(19) United States
(12) Patent Application Publication
(10) Pub. No.: US 2012/0163813 A1
(43) Pub. Date: Jun. 28, 2012

(54) IMPROVEMENTS IN OPTICAL NETWORKS

(76) Inventors: Renato Grosso, Genova (IT); Lorenzo Machionni, Genova (IT); Lisa Quadrini, Genova (IT)

(21) Appl. No.: 13/391,542

(22) PCT Filed: Aug. 19, 2009
(86) PCT No.: PCT/EP2009/060736

§ 371 Date: Mar. 12, 2012

(51) Int. Cl. H04J 14/02

(52) U.S. Cl. 398/49; 398/79

(57) ABSTRACT

An optical network (10) comprises a first optical transmitter (12), a first controller (14), optical receiver apparatus (16) and an optical network element (20) comprising an optical receiver (22), a second optical transmitter (24), and a second controller (26). The first controller controls the first optical transmitter to generate and transmit a first optical signal having a first signal format until the optical receiver apparatus detects the second optical signal and subsequently controls it to apply a second signal format to said first optical signal. The second controller (26) controls the second optical transmitter to iteratively generate and transmit the second optical signal at different wavelength until a first optical having a second signal format is detected. The second controller subsequently maintains generation and transmission of the second optical signal at the wavelength at which the first optical signal was identified as having the second signal format.

### FIELD OF THE INVENTION

The invention relates to an optical network, an optical network element, an optical line termination, a method of configuring a wavelength of an optical transmitter in an optical network and a method of remotely setting a wavelength of an optical transmitter in an optical network.

### BACKGROUND OF THE INVENTION

Optical network technology is moving towards providing fibre to the home utilizing wavelength division multiplexing (WDM). One particular solution for fibre to the home is wavelength division multiplexed passive optical networks (WDM-PON) in which a separate wavelength channel is used to communicate from the central office (CO) optical line termination (OLT) to the optical network unit (ONU) at each home. This approach creates a virtual point-to-point link between the CO and each ONU, in contrast to the point to multipoint topology of a regular PON. The WDM-PON network architecture requires that each ONU transmits upstream on a different wavelength. Providing each ONU with a different fixed wavelength transmitter is a costly approach and has maintenance problems associated with it. An alternative, more attractive, approach is to provide tunable lasers as the transmitters in each ONU. However, using tunable lasers at the ONUs faces the problem of tuning each laser to the correct wavelength for its associated channel.

### SUMMARY OF THE INVENTION

It is an object to provide an improved optical network. It is a further object to provide an improved optical network element. It is a further object to provide an improved optical line termination. It is a further object to provide an improved method of configuring a wavelength of an optical transmitter in an optical network. It is a further object to provide an improved method of remotely setting a wavelength of an optical transmitter in an optical network.

A first aspect of the invention provides an optical network comprising a first optical transmitter, a first controller, optical receiver apparatus and an optical network element. Said first optical transmitter is arranged to generate and transmit a first optical signal. Said first controller is arranged to control said first optical transmitter to apply a signal format to said first optical signal. Said optical receiver apparatus is arranged to detect an optical signal having a wavelength within a receiving wavelength band. Said optical network element comprises an optical receiver, a second optical transmitter and a second controller. Said optical receiver is arranged to detect a said first optical signal. Said second optical transmitter is arranged to generate and transmit a second optical signal. Said second controller is arranged to control said second optical transmitter to generate and transmit said second optical signal at a wavelength selected from a predetermined plurality of wavelengths. Said first controller is arranged to control said first optical transmitter to apply a first signal format to said first optical signal until said optical receiver apparatus detects said second optical signal. Said first controller is arranged to subsequently control said first optical transmitter to apply a second signal format to said first optical signal. Said second controller is arranged to identify said signal format of a received first optical signal. Said second controller is arranged control said second optical transmitter to iteratively generate and transmit said second optical signal at different wavelengths of said predetermined plurality of wavelengths until said second controller identifies a received first optical signal as having said second signal format. Said second controller is further arranged to subsequently maintain generation and transmission of said second optical signal at said wavelength at which said first optical signal is identified as having said second signal format. The optical network is thus able to configure the wavelength of an optical transmitter at an optical network element based simply on the detection of a change in the signal format of the first optical signal. The configuration of the wavelength of an optical transmitter is thus controlled by simple messaging implemented at the physical layer of the network.

In an embodiment, said optical receiver apparatus comprises an optical detector coupled to an output port of a wavelength selective router. Said router is arranged to transmit an optical signal having a wavelength within said receiving wavelength band to said optical detector and to substantially block an optical signal having a wavelength outside said receiving wavelength band. In an embodiment, said wavelength selective router comprises a wavelength division de-multiplexer. In an embodiment, said receiving wavelength band covers a spectral range which includes the wavelength of only one channel on a wavelength division multiplexed channel grid, and thus only one channel within said optical network. In an embodiment, said wavelength selective router comprises an arrayed waveguide grating. Said output port is arranged to transmit an optical signal having a wavelength within said receiving wavelength band. Optical signals having a wavelength outside said receiving wavelength band are substantially attenuated. In an embodiment, said optical detector has a sensitivity threshold which is higher than a maximum adjacent crosstalk of said output port. Optical signals resulting from cross-talk from other output ports of the arrayed waveguide grating are therefore not detected. In an embodiment, said second optical transmitter is arranged to generate and transmit a second optical signal having an optical power which is not greater than a difference between said sensitivity threshold and an attenuation experienced by said second optical signal. This ensures that the second optical signal will only be detected when its wavelength falls within the receiving wavelength band.

In an embodiment, said second optical transmitter comprises a wavelength tuneable optical source, such as a wavelength tuneable laser. In an alternative embodiment, said second optical transmitter comprises a plurality of fixed wavelength optical sources.

In an embodiment, said second controller is further arranged to control transmission of said second optical signal in response to detecting said first optical signal. The optical network is thus provided with improved laser safety and lower power usage.

In an embodiment, said optical receiver comprises wideband optical receiver.

In an embodiment, said first signal format comprises a pulsed optical signal and said second signal format comprises a continuous wave optical signal. In an embodiment, said second controller is arranged to control said second optical transmitter to transmit said second optical signal in response to detecting an edge of a pulse of said pulsed optical signal. In an embodiment, said second controller is arranged to control said second optical transmitter to transmit said second optical signal in response to detecting a falling edge of a pulse of said pulsed optical signal.

In an alternative embodiment, said first signal format comprises a continuous wave optical signal and said second signal format comprises a pulsed optical signal.

Said pulsed optical signal is generated by said first optical transmitter cycling from a power on state to a power off state and back to said power on state.

In an embodiment, said optical network comprises a plurality of said optical network elements, a said plurality of first optical transmitters and a said plurality of optical detectors. Each said optical detector is arranged to detect an optical signal having a wavelength within a different receiving wavelength band. Each optical detector thus detects signals corresponding to a different channel of said network. Said optical detectors are coupled to respective output ports of said wavelength selective router. In an embodiment, said plurality of said optical network units are connected to said wavelength selective router via a wavelength division multiplexer. In an embodiment, said wavelength division multiplexer comprises an arrayed waveguide grating.

In an embodiment, said first optical transmitter, said first controller and said optical receiver apparatus are provided within an optical line termination.

In an embodiment, said optical network comprises a passive optical network and said first optical signal comprises a downlink optical carrier signal and said second optical signal comprises an uplink optical carrier signal.

A second aspect of the invention provides an optical network element comprising an optical receiver, an optical transmitter and a controller. Said optical receiver is arranged to detect a first optical signal. Said optical transmitter is arranged to generate and transmit a second optical signal. Said controller is arranged to control said optical transmitter to generate and transmit said second optical signal at a wavelength selected from a predetermined plurality of wavelengths. Said controller is arranged to identify a signal format of a received first optical signal. Said controller is arranged to control said optical transmitter to iteratively generate and transmit said second optical signal at different wavelengths of said predetermined plurality of wavelengths until said controller identifies a received first optical signal as having a second signal format. Said controller is further arranged to subsequently maintain generation and transmission of said second optical signal at said wavelength at which said first optical signal is identified as having said second signal format.

The optical network element is thus able to have the wavelength of its optical transmitter configured based simply on the detection of a change in the signal format of a first optical signal. The configuration of the wavelength of the optical transmitter can thus be controlled by simple messaging implemented at the physical layer of an optical network within which the optical network element is incorporated.

In an embodiment, said optical transmitter is arranged to generate and transmit a second optical signal having an optical power which is not greater than the difference between a sensitivity threshold of an optical detector adapted to detect said second optical signal when said second optical signal is at a wavelength within a receiving wavelength band and an attenuation experienced by said second optical signal on transmission across an optical network comprising said optical network element.

In an embodiment, said optical transmitter comprises a wavelength tuneable optical source, such as a wavelength tuneable laser. In an alternative embodiment, said optical transmitter comprises a plurality of fixed wavelength optical sources.

In an embodiment, said controller is further arranged to control said optical transmitter to generate and transmit said second optical signal in response to detecting said first optical signal.

In an embodiment, said optical receiver comprises wideband optical receiver.

In an embodiment, said first signal format comprises a pulsed optical signal and said second signal format comprises a continuous wave optical signal. In an embodiment, said controller is arranged to control transmission of said second optical signal in response to detecting an edge of a pulse of said pulsed optical signal. In an embodiment, said controller is arranged to control transmission of said second optical signal in response to detecting a falling edge of a pulse of said pulsed optical signal.

A third aspect of the invention provides an optical line termination comprising an optical transmitter, a controller, and optical receiver apparatus. Said optical transmitter is arranged to generate and transmit a first optical signal. Said controller is arranged to control said optical transmitter to apply a signal format to said optical signal. Said optical receiver apparatus is arranged to detect an optical signal having a wavelength within a receiving wavelength band. Said controller is arranged to control said optical transmitter to apply a first signal format to said first optical signal until said optical receiver apparatus detects a second optical signal. Said controller is arranged to subsequently control said optical transmitter to apply a second signal format to said first optical signal.

The optical line termination is thus adapted to control the signal format of a first optical signal generated and transmitted by its optical transmitter in response to detection of a second optical signal.

In an embodiment, said optical receiver apparatus comprises an optical detector and a wavelength selective router. Said router is arranged to transmit an optical signal having a wavelength within said receiving wavelength band to said optical detector and to substantially attenuate an optical signal having a wavelength outside said receiving wavelength band. In an embodiment, said wavelength selective router comprises a wavelength division multiplexer.

In an embodiment, said optical receiver apparatus comprises an optical detector coupled to an output port of an arrayed waveguide grating. Said output port is arranged to transmit an optical signal having a wavelength within said receiving wavelength band. Optical signals having a wavelength outside said receiving wavelength band are substantially attenuated. In an embodiment, said optical detector has a sensitivity threshold which is higher than a maximum adjacent crosstalk of said output port.

In an embodiment, said first optical signal format comprises a pulsed optical signal and said second optical signal format comprises a continuous wave optical signal. In an alternative embodiment, said first optical signal format comprises a continuous wave optical signal and said second optical signal format comprises a pulsed optical signal. Said pulsed optical signal is generated by the first optical transmitter repeatedly cycling from a power on state to a power off state and back to said power on state.

A fourth aspect of the invention provides a method of configuring an optical transmitter in an optical network. The method comprises generating and transmitting a first optical signal having a first signal format. The method comprises, at said optical transmitter, generating and transmitting a second optical signal. Said second optical signal is of a wavelength selected from a predetermined plurality of wavelengths. The method comprises receiving said second optical signal at an optical receiver apparatus. Said optical receiver apparatus is arranged to detect an optical signal having a wavelength within a receiving wavelength band. Any optical signal received which has a wavelength outside said receiving wavelength band will not be detected. If said second optical signal is at a wavelength within said receiving wavelength band, the method comprises detecting said second optical signal, and generating and transmitting said first optical signal in a second signal format. The method comprises detecting said change in said signal format and setting said wavelength of said second optical signal to said selected wavelength. If said second optical signal is not at a wavelength within said receiving wavelength band, said second optical signal is not detected. Said method then comprises further generating and transmitting said first optical signal in said first signal format. Said second optical signal is then generated and transmitted at a different wavelength selected from said predetermined plurality of wavelengths. If said different selected wavelength is at a wavelength within said receiving wavelength band, said second optical signal is detected and said wavelength of said second optical signal is set to said selected wavelength. If said different selected wavelength is not at a wavelength within said receiving wavelength band, said second optical signal is not detected and said method comprises repeating said selection of a different wavelength and generation and transmission of said second optical signal until said wavelength of said second optical signal is within said receiving wavelength band and said second optical signal is detected by said optical receiver apparatus. When said second optical signal is detected said wavelength of said second optical signal is set at the currently selected wavelength.

The method enables the wavelength of an optical transmitter to be configured based on detecting a change in the signal format of a first optical signal. The method thus configures the wavelength of the optical transmitter is by implementing simple messaging at the physical layer of the network.

In an embodiment, said second optical signal is transmitted in response to detecting said first optical signal. The method thus prevents generation and transmission of the second optical signal until the first optical signal is detected. This improves laser safety and reduces power consumption of the network since the second optical transmitter will not generate and transmit the second optical signal if it is not connected to the network and if it has not been configured for use.

In an embodiment, said method comprises detecting said second optical signal only when said second optical signal has an optical power which is equal to or greater than an optical receiver sensitivity threshold. This ensures that cross-talk optical signals and signals of an incorrect wavelength are not erroneously detected.

In an embodiment, said second optical signal has an optical power which is not greater than the difference between said optical receiver sensitivity threshold and an attenuation experienced by said second optical signal. This ensures that the second optical signal is only detected when it is of the correct wavelength, since any optical signals at an incorrect wavelength will undergo higher attenuation and so will not breach the sensitivity threshold.

In an embodiment, said first optical signal format comprises a pulsed optical signal and said second optical signal format comprises a continuous wave optical signal. In an alternative embodiment, said first optical signal format comprises a continuous wave optical signal and said second optical signal format comprises a pulsed optical signal.

Said method may be applied concurrently to a plurality of optical transmitters in an optical network. Said method comprises generating and transmitting a plurality of first optical signals having a first signal format, each said first optical signal being of a different wavelength. Said method comprises, at each said optical transmitter, generating and transmitting a second optical signal. Said method comprises receiving said second optical signals respectively at a said plurality of optical receiver apparatus. Each said optical receiver apparatus is arranged to detect an optical signal having a wavelength within a different receiving wavelength band. The method is thus able to be used to simultaneously configure the wavelengths of a plurality of optical transmitters.

A fifth aspect of the invention comprises a method of remotely setting a wavelength of an optical transmitter in an optical network. The method comprises, at a location remote from said optical transmitter, generating and transmitting a first optical signal having a first signal format. Said first optical signal is generated and transmitted until a second optical signal, generated by said optical transmitter, is detected. Said method further comprises subsequently generating and transmitting said first optical signal in a second signal format.

The format of the first optical signal is thus controlled by simple detection of the presence or absence of a second optical signal, providing control of the signal formal by simple physical layer messaging.

In an embodiment, said first signal format comprises a pulsed optical signal and said second signal format comprises a continuous wave optical signal. In an embodiment, said method comprises detecting said second optical signal only when said second optical signal has an optical power which is equal to or greater than an optical receiver sensitivity threshold.

A sixth aspect of the invention provides a method of setting a wavelength of an optical transmitter of an optical network. Said method comprises, at said optical transmitter, generating and transmitting a first optical signal at a wavelength selected from a predetermined plurality of wavelengths. Said method further comprises receiving and detecting a second optical signal at a location of said optical transmitter. Said second optical signal has one of a first signal format and a second signal format. Said first optical signal is iteratively generated and transmitted at different wavelengths of said predetermined plurality of wavelengths until a change said signal format of said second optical signal is detected. Said method further comprises subsequently maintaining generating and transmitting said first optical signal at said wavelength at which said change in said signal format of said second optical signal is detected. The method enables the wavelength of an optical transmitter to be set based on detecting a change in the signal format of the second optical signal. The method thus configures the wavelength of the optical transmitter is by implementing simple messaging at the physical layer of the network.

In an embodiment, said first optical signal is transmitted in response to detecting said second optical signal.

In an embodiment, said first optical signal format comprises a pulsed optical signal and said second optical signal format comprises a continuous wave optical signal. In an alternative embodiment, said first optical signal format comprises a continuous wave optical signal and said second optical signal format comprises a pulsed optical signal.

A seventh aspect of the invention comprises a data carrier having computer readable instructions embodied therein. The said computer readable instructions are for providing access to resources available on a processor. The computer readable instructions comprise instructions to cause the processor to perform any of the above steps of the method of configuring a wavelength of an optical transmitter in an optical network.

An eighth aspect of the invention comprises a data carrier having computer readable instructions embodied therein. The said computer readable instructions are for providing access to resources available on a processor. The computer readable instructions comprise instructions to cause the processor to perform any of the above steps of the method of remotely setting a wavelength of an optical transmitter in an optical network.

### BRIEF DESCRIPTION OF THE DRAWINGS

FIG. 1 is a schematic representation of an optical network according to a first embodiment of the invention;

FIG. 2 is a schematic representation of an optical network according to a second embodiment of the invention;

FIG. 3 shows a representation of a) a first optical signal generated and transmitted by the first optical transmitter of the optical network of FIG. 1 or 2; b) the first optical signal as received at the optical receiver of the optical network element; c) a second optical signal generated and transmitted by the second optical transmitter; and d) the second optical signal received at the optical receiver apparatus;

FIG. 4 is a schematic representation of an optical network according to a third embodiment of the invention;

FIG. 5 is a representation of the arrayed waveguide grating of the optical network of FIG. 4;

FIG. 6 is a schematic representation of the two arrayed waveguide gratings of FIG. 4;

FIG. 7 is a schematic representation of an optical network element according to a fourth embodiment of the invention;

FIG. 8 is a schematic representation of an optical line termination according to a fifth embodiment of the invention;

FIG. 9 is a flow diagram of the steps of a method of configuring an optical transmitter in an optical network according to a sixth embodiment of the invention;

FIG. 10 is a flow diagram of the steps of a method of configuring an optical transmitter in an optical network according to a seventh embodiment of the invention; and

FIG. 11 shows the steps of a method of remotely setting a wavelength of an optical transmitter in an optical network according to an eighth embodiment of the invention.

### DESCRIPTION OF EMBODIMENTS OF THE INVENTION

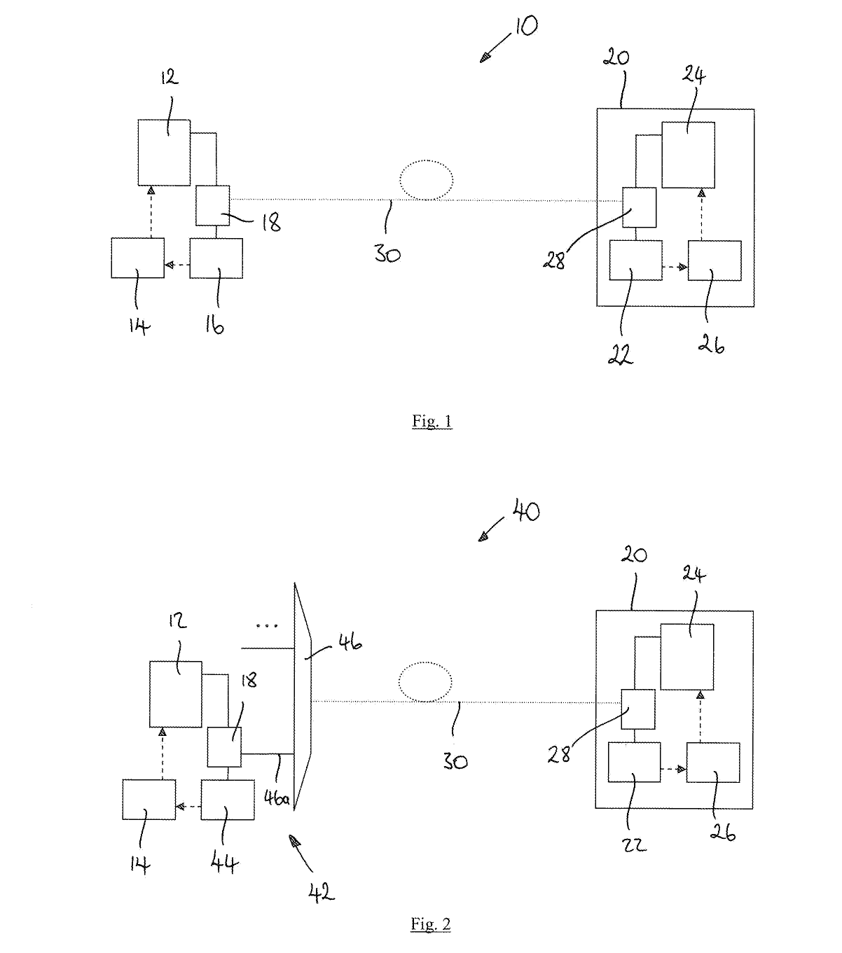

Referring to FIG. 1, a first embodiment of the invention provides an optical network 10 comprising a first optical transmitter 12, a first controller 14, optical receiver apparatus 16 and an optical network element 20.

The first optical transmitter 12 is arranged to generate and transmit a first optical signal. The first controller 14 is arranged to control the first optical transmitter 12 to apply a signal format to the first optical signal. The signal format may comprise a pulsed optical signal or a continuous wave optical signal. The optical receiver apparatus 16 is arranged to detect an optical signal having a wavelength within a receiving wavelength band. In the case of a wavelength division multiplexed (WDM) optical network, the receiving wavelength band encompasses a single channel on a WDM grid and thus a single channel of the optical network 10.

The first optical transmitter 12 and the optical receiver apparatus 16 will typically be coupled to an optical link 30 through a band split filter 18. The optical link 30, which does not form part of this embodiment, will typically connect the band split filter 18 to the optical network element 20.

In this example, the first controller 14 comprises a microprocessor programmed to appropriately control the first optical transmitter 12 to apply the desired signal format to the first optical signal.

The optical network element, which here comprises an optical network unit (ONU) 20 comprises an optical receiver 22, a second optical transmitter 24, a second controller 26 and a second band split filter 28. The second optical transmitter 24 comprises a wavelength tuneable optical transmitter, which in this example comprises a wavelength tuneable laser. The second controller 26 is arranged to control the second optical transmitter to generate and transmit a second optical signal. The wavelength of the second optical signal is selected by the second controller from a pre-determined plurality of wavelengths. The wavelengths comprise those within a WDM grid of the optical network, so that the wavelength of the second optical signal is selected from one of the pre-determined wavelengths of the optical channels of the optical network 10.

The first controller 14 is arranged to control the first optical transmitter 12 to apply a first signal format, for example a pulsed signal format, to the first optical signal until the optical receiver apparatus 16 detects a second optical signal received from the ONU 20. The first controller 14 is arranged to detect the second optical signal and to subsequently control the first optical transmitter 12 to apply a second signal format to the first optical signal. The first optical transmitter 12 therefore generates and transmits a first optical signal having a first signal format until the second optical signal is generated at the correct wavelength, allowing the second optical signal to be detected by the optical receiver apparatus 16. Following detection of the second optical signal the first controller 14 controls the first optical transmitter 12 to apply the second signal format to the first optical signal.

The second controller 26 comprises a microprocessor which is appropriately programmed to identify the signal format of a received first optical signal, and to control the second optical transmitter 24 to iteratively generate and transmit the second optical signal at different ones of the pre-determined plurality of wavelengths. The second controller 26 is provided with a memory device in which the pre-determined plurality of wavelengths are stored and is appropriately programmed to control the second optical transmitter 24 to iteratively generate and transmit the second optical signal at different wavelengths of the pre-determined plurality of wavelengths. The second controller 26 is arranged to control the second optical transmitter 24 to generate and transmit the second optical signal at different ones of the pre-determined plurality of wavelengths in a pre-determined manner.

The use of microprocessors as the first controller 14 and the second controller 26 provides the advantage that the optical network 10 is adapted to set the wavelength of the second optical transmitter 24 using simple and inexpensive devices.

The optical receiver 22 is arranged to detect a first optical signal generated and transmitted by the first optical transmitter 12. The second controller 26 controls the second optical transmitter 24 to iteratively generate and transmit a second optical signal at different wavelengths of the pre-determined plurality of wavelengths while the first optical signal is detected and identified as having the first signal format. Once the second controller 26 identifies a received first optical signal as having the second signal format, the iterative generation and transmission of the second optical signal at different wavelengths is halted. The second controller 26 is further arranged to subsequently maintain generation and transmission of the second optical signal at the wavelength at which a first optical signal was identified as having the second signal format.

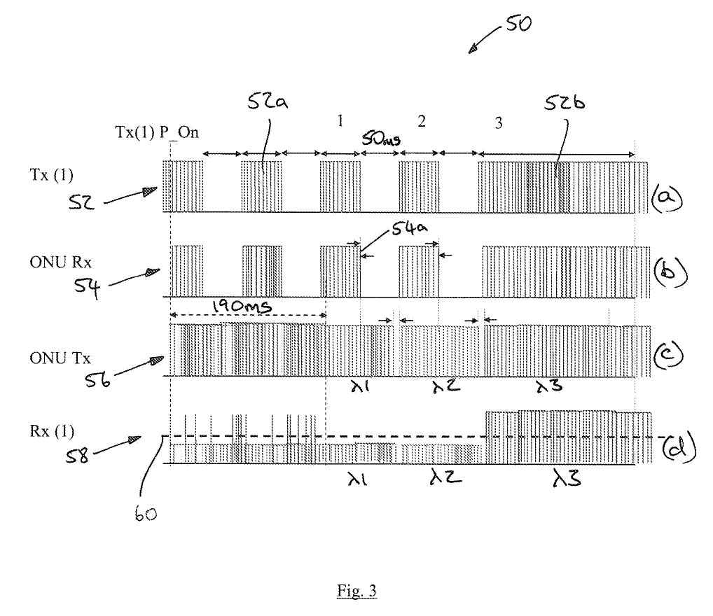

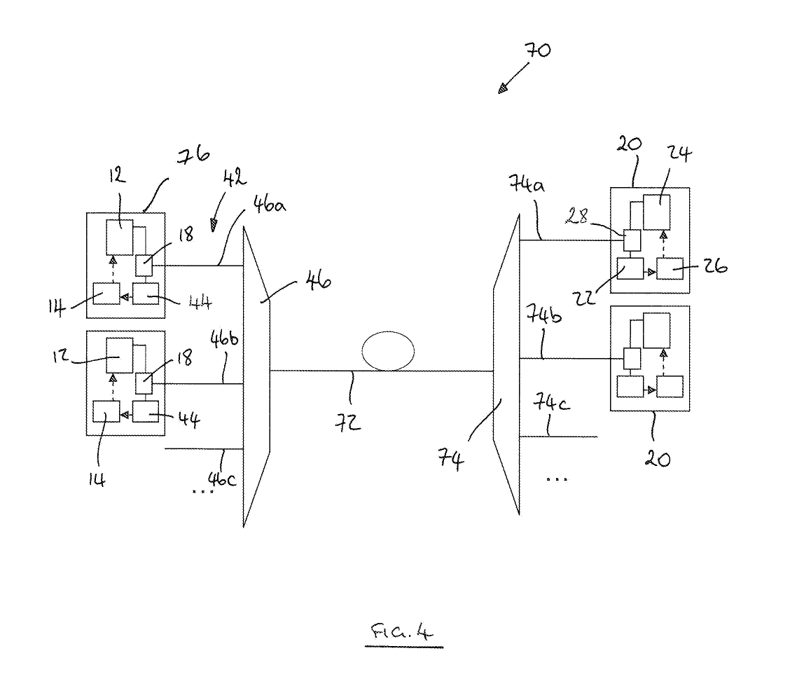

Referring to FIGS. 2 and 3, a second embodiment of the invention provides an optical network 40 which is substantially the same as the optical network 10 of the first embodiment, with the following modifications. The same reference numbers are retained for corresponding features.

The optical network 40 comprises a first optical transmitter 12, a first controller 14, optical receiver apparatus 42 and an ONU 20.

The optical receiver apparatus 42 comprises an optical detector 44 coupled to an output port 46a of a wavelength selective router 46. In this example, the wavelength selective router 46 comprises an arrayed waveguide grating (AWG). The output port 46a of the AWG 46 is arranged to transmit an optical signal having a wavelength within a receiving wavelength band of the optical detector 44. That is to say, the output port 46 is arranged to transmit a single channel of a WDM grid, being a single channel of the optical network 40. The optical detector 44 has a sensitivity threshold, being a minimum optical power below which the optical detector 44 will not detect received optical signals.

As will be well known to the person skilled in the art, AWGs experience some cross-talk between their various channels/ports caused by optical signals on one channel leaking into adjacent channels, and thus arriving at the wrong output port of the AWG. Although AWGs are able to almost completely cancel out of band wavelengths, being wavelengths outside the receiving wavelength band of a particular channel, some cross-talk will nevertheless exist between channels of an AWG. In this example, the AWG 46 is designed to have a maximum adjacent cross-talk of −31 db, i.e. a cross-talk signal or a signal at the wrong wavelength for a channel will experience an attenuation of −31 db on transmission through the AWG, so the maximum cross-talk power of an optical signal leaking from one channel to an adjacent channel will be −31 db of its in channel power. The sensitivity of the optical detector 44 is selected to be higher than the maximum adjacent cross-talk power of the output port 46a, so that even where cross-talk signals do appear at the output port 46a, the detector 44 will not detect these signals. This ensures that the detector 44 only detects a second optical signal of the correct wavelength.

As for the previous embodiment, the optical network 40 will typically additionally comprise an optical link 30, which in this example extends between the AWG 46 and the band split filter 28 of the ONU 20. The optical link 30 does not form part of this embodiment.

In order to ensure that the second optical signal is only detected when it is of the correct wavelength, the second optical transmitter 24 is arranged to generate and transmit a second optical signal having an optical power which is not greater than the difference between the sensitivity threshold of the optical detector 44 and the attenuation experienced by the second optical signal on transmission through the AWG 46 when the second optical signal is not of the correct wavelength. In this example, the second optical signal has an optical power of 3 dbm and the optical detector 44 has a sensitivity threshold of −28 dbm. The AWG 46 attenuates out of band optical signals by −31 db, ensuring that any optical signal routed to the output port 46a which is not of the correct wavelength is well below the sensitivity threshold of the optical detector 44. A typical optical link 30 comprises a single mode optical fibre having 0.22 db/km of insertion loss at 1550 nm. A 100 kilometre length of optical fibre as the optical link 30 would therefore have an insertion loss of −22 db. A second optical signal having an optical power of 3 dbm will thus arrive at the output port 46a of the AWG having an optical power of −19 dbm if it is of the correct wavelength, which is well above the sensitivity threshold of the optical detector 44.

In use, at power on, the first optical transmitter 12 commences generating and transmitting a first optical signal having a pulsed signal format, as shown in FIG. 3a. The pulses 52a are created by the first optical transmitter 12 cycling from a power on state to a power off state. At the same time, the second optical transmitter 24 is powered on and starts transmitting. An initial period of time is generally required for a tuneable laser to reach a stable wavelength for transmission, which may typically be 190 milliseconds, as illustrated in FIG. 3c. The first optical signal is received at the optical receiver 22 and the second controller 26 identifies the signal format of the received first optical signal. In this example, the first optical signal is identified as having a pulsed format by the second controller 26 identifying the transition from power on to power off of the first optical transmitter 12, i.e. by detecting a falling edge 54a of a pulse, as shown in FIG. 3b. On detecting the first optical signal, the second controller 26 controls the second optical transmitter 24 to generate and transmit a second optical signal at a first wavelength, λ1. In this example, λ1 is not the correct wavelength for the respective output port 46a, and as shown in FIG. 3d the power of the second optical signal at the output port 46a of the AWG 46 is below the receiver sensitivity 60 of the optical detector 44. The second optical signal is therefore not detected.

As the second optical signal was not detected at the optical detector 44, the first optical signal is continued to be transmitted in its first signal format 52a and the second controller 26 identifies a subsequent falling edge 54a of the first optical signal and controls the second optical transmitter 24 to generate and transmit at a second wavelength, λ2. The second controller 26 continues to control the second optical transmitter 24 to iteratively generate and transmit the second optical signal at different wavelengths of the pre-determined plurality of wavelengths until the second optical is received at the output port 46a of the AWG 46 having an optical power above the sensitivity threshold of the photo-detector 44, indicating that the second optical signal is of the correct wavelength and falls within the receiving band width of the optical detection apparatus 42. Following detection of the second optical signal, λ3 in FIG. 3, the first controller 14 controls the first optical transmitter to apply a second signal format 52b, in this example a continuous wave optical signal, to the first optical signal. Following receipt of the first optical signal in the second signal format, the second controller 26 identifies the change in the signal format of the first optical signal and controls the second optical transmitter 24 to maintain generation and transmission of the second optical signal at the last attempted wavelength, i.e. λ3.

It will be appreciated that the second controller 26 applies a time delay between each iterative generation and transmission of the second optical signal, to allow time for the second optical signal to be transmitted across the optical link 30 and any resulting change in the signal format of the first optical signal to be implemented and the first optical signal to be subsequently detected.

Referring to FIG. 4, a third embodiment of the invention provides an optical network 70. The same reference numbers are retained for features corresponding to those of the previous embodiments.

In this embodiment, the optical network 70 comprises an optical link 72, an AWG 74, a plurality of ONUs 20, a plurality of optical line terminations (OLT) 76 and a second AWG 46.

Each OLT 76 comprises a first optical transmitter 12, a first controller 14, an optical detector 44 and a band split filter 18. Each OLT 76 is coupled to an input port 46a, 46b etc of the AWG 46. The AWG 46 is coupled via the optical link 72 to the AWG 74. Each of the plurality of ONUs 20 is coupled to an output port 74a, 74b, etc of the AWG 74.

The first optical transmitter 12 of each OLT 76 generates a first optical signal at one of a pre-determined set of wavelengths, according to its AWG port 46a, 46b etc. Each OLT 76 is paired with an ONU 20 and the setting of the wavelength of the second optical transmitter 24 of the ONU 20 of each pair proceeds as described above.

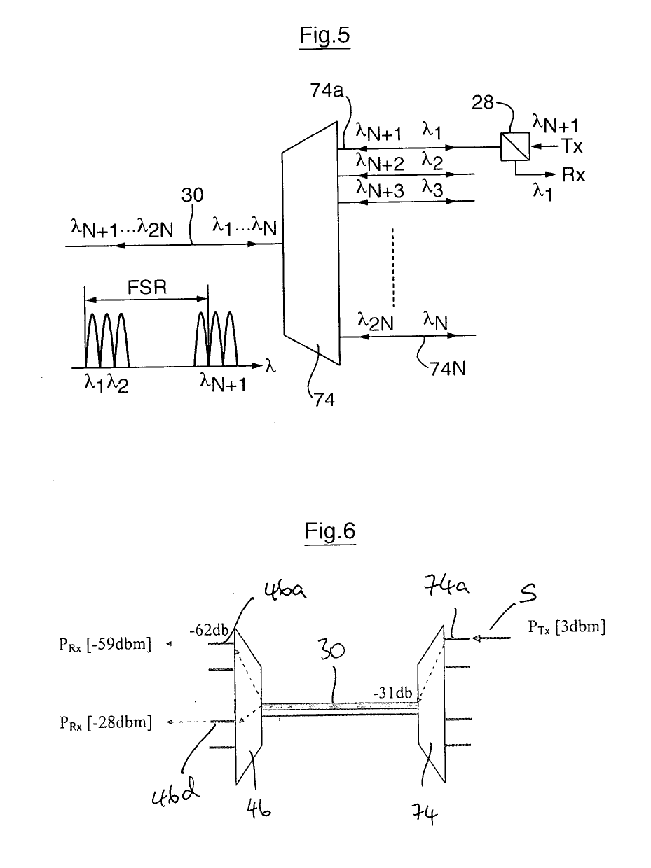

The wavelength of the first optical signal is provided within a first free spectral range of the AWG 46, for example the C band, and the wavelengths from which the second optical signal is selected are provided within a second free spectral range of the AWG 46, for example the L band. The cyclic nature of the AWG 46 is thus used for the downstream first optical signal and the upstream second optical signal, as illustrated in FIG. 5.

As illustrated in FIG. 6, a second optical signal (S) having, for example a red wavelength, incorrectly routed through a first, for example blue, port 74a of the AWG 74 will suffer an attenuation of −31 db on transmission through the AWG 74. Including some attenuation on transmission across the optical link 30, as described above, this results in the optical signal having an optical power of below −28 dbm at an output port 46d at the AWG 46, being a red port, i.e. when the optical signal is of the correct wavelength for that output port 46d. This is below the sensitivity threshold of the detector 44 at the port 46d and so will not be detected. Any cross-talk optical signal arriving at a blue port, say 46a, will experience a further −31 db of attenuation on transmission through the AWG 46 due to it being of the incorrect wavelength for that port, resulting in an output power of −59 dbm or lower. If the second optical signal (S) was instead routed through a red port, 74d, of the AWG 74 it will not experience any attenuation on transmission through the AWG 74. On transmission through the AWG 46 to the red port 46d it will similarly experience no attenuation, so will have an optical power pf 3 dbm less the attenuation caused by transmission across the optical link 30. Any cross-talk optical signal arriving at the blue port 46a of the AWG 46 will experience −31 db of attenuation on transmission through the AWG 46 plus attenuation across the optical link 30 and will have a resulting optical power of less than −28 dbm. A red second optical signal routed through red ports 74d, 46d will therefore arrive at the optical detector 44 having a power of 3 dbm (less any power loss due to attenuation across the optical link 30) and will thereby be detected by the optical detector 44 at its intended output port and will not be detected at an optical detector 44 at any other output port. The optical link 30 can have up to −30 db, which would result in an optical power of −27 dbm for a red second optical signal routed via red port 74d, 46d, without affecting the operation of the optical network 70.

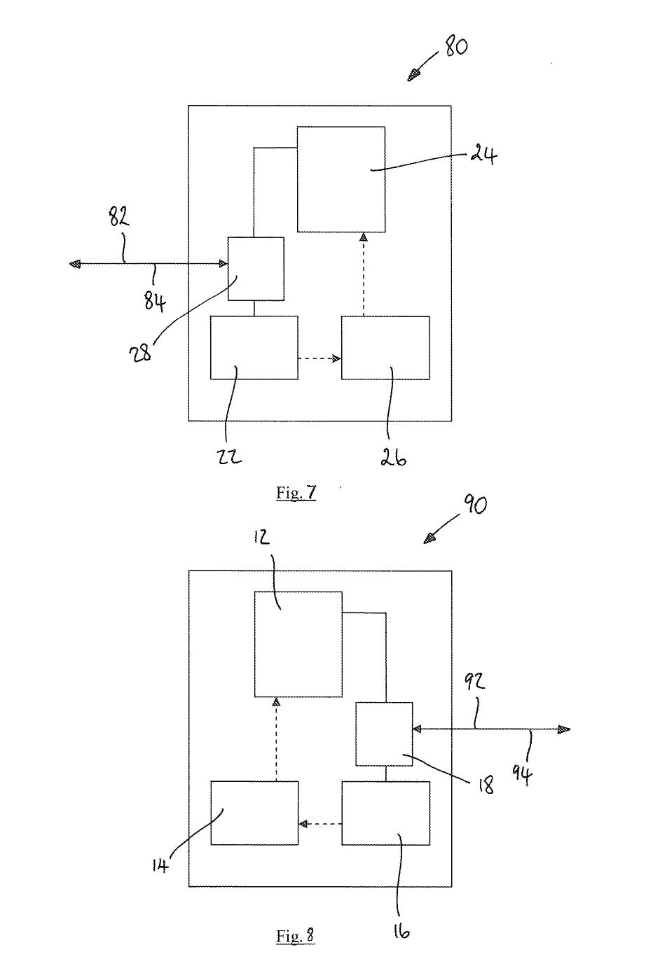

Referring to FIG. 7, a fourth embodiment of the invention provides an optical network element 80. The same reference numbers are retained for features corresponding to the previous embodiments.

The optical network element 80 comprises an optical receiver 22, an optical transmitter 24 and a controller 26. The optical network element 80 further comprises a band-split filter 28. The optical receiver 22 is arranged to detect a first optical signal 82. The optical transmitter 24 is arranged to generate and transmit a second optical signal 84. The controller 26 is arranged to control the optical transmitter 24 to iteratively generate and transmit the second optical signal at wavelength selected from a pre-determined plurality of wavelengths, as described above. The controller 26 is arranged to identify a signal format of a received first optical signal 82. The controller 26 is arranged to control the optical transmitter 24 to iteratively generate and transmit the second optical signal 84 at different wavelengths of the pre-determined plurality of wavelengths until the controller 26 identifies a received first optical signal as having a second signal format. The controller 26 is arranged to subsequently maintain generation and transmission of the second optical signal at the wavelength at which the first optical signal is identified as having the second signal format.

In this example, the optical transmitter 24 comprises a tuneable laser and the controller 26 is arranged to control the optical transmitter 24 to iteratively generate and transmit the second optical signal 84 at wavelengths comprising the wavelengths of a WDM grid, being the wavelengths of the channels of an optical network in which the optical network element 80 is intended to be incorporated.

The controller 26 comprises a microprocessor which is appropriately programmed to identify the signal format of a received first optical signal, and to control the optical transmitter 24 to iteratively generate and transmit the second optical signal at different ones of the pre-determined plurality of wavelengths. The controller 26 is provided with a memory device in which the pre-determined plurality of wavelengths are stored and is appropriately programmed to control the optical transmitter 24 to iteratively generate and transmit the second optical signal at different wavelengths of the pre-determined plurality of wavelengths. The controller 26 is arranged to control the optical transmitter 24 to generate and transmit the second optical signal at different ones of the pre-determined plurality of wavelengths in a pre-determined manner.

A fifth embodiment of the invention provides an optical line termination 90, as shown in FIG. 8. The same reference numbers are retained for features which correspond to those of previous embodiments.

The optical line termination (OLT) 90 comprises an optical transmitter 12, a controller 14, and optical receiver apparatus 16. The OLT 90 further comprises a band-split filter 18.

The optical transmitter 12 is arranged to generate and transmit a first optical signal 92. The controller is arranged to control the optical transmitter 12 to apply a signal format to the first optical signal 92. The signal format in this example is a pulsed optical signal. The optical receiver apparatus 16 is arranged to detect an optical signal having a wavelength within a receiving wavelength band. In this example, the receiving wavelength band comprises a single channel within a WDM grid, being a single channel of an optical network into which the OLT 90 is intended to be incorporated. The optical receiver apparatus 16 is thus arranged to detect optical signals at a single WDM grid wavelength.

The controller 14 is arranged to control the optical transmitter 12 to apply a first signal format to the first optical signal until the optical receiver apparatus 16 detects a second optical signal 94 That is to say until the optical receiver apparatus 16 detects a second optical signal at a desired WDM grid wavelength. The controller 14 is arranged to subsequently control the optical transmitter 12 to apply a second signal format to the first optical signal 92. The second signal format would typically be a continuous wave optical signal. It will be appreciated that the signal format may alternatively be a continuous wave optical signal and the second signal format a pulsed optical signal.

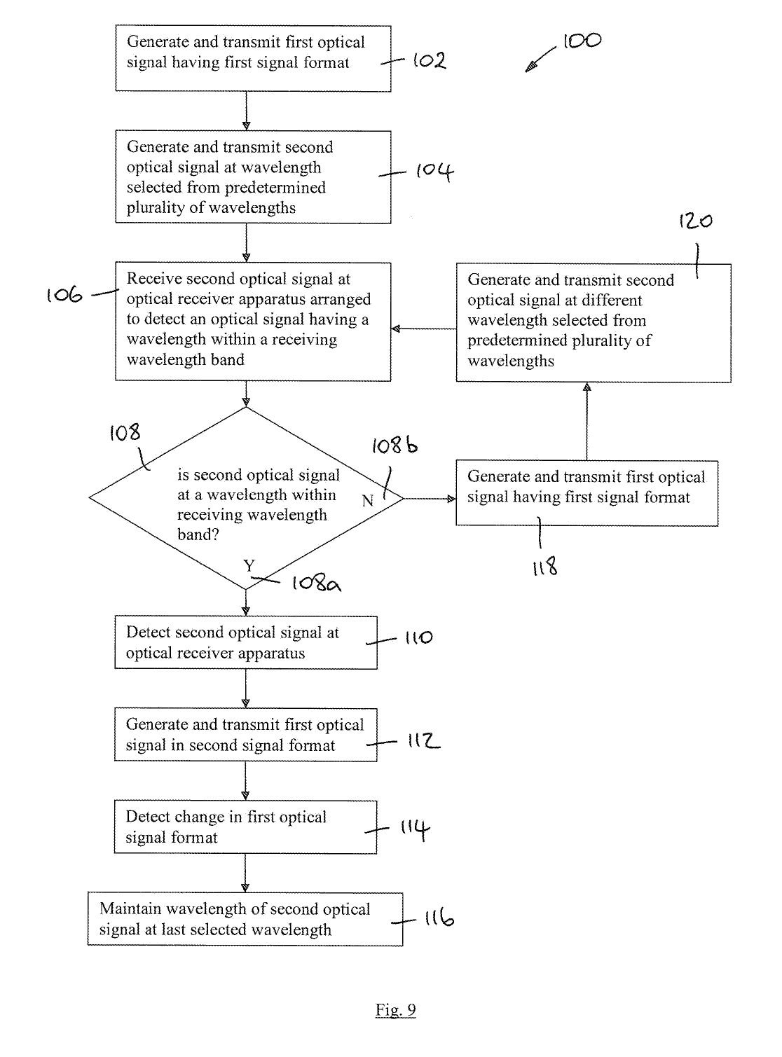

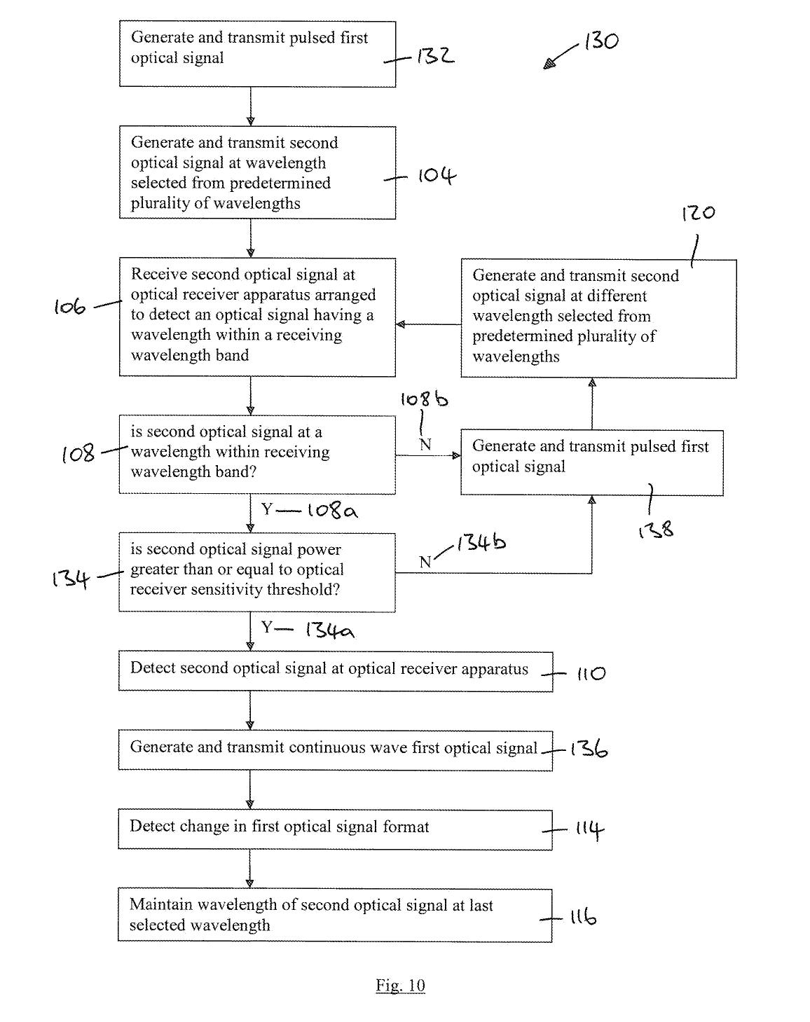

Referring to FIG. 9, a sixth embodiment of the invention provides a method 100 of configuring an optical transmitter in an optical network.

The method 100 comprises generating and transmitting a first optical signal having a first signal format 102. A second optical signal is generated and transmitted at said optical transmitter 104. Said second optical signal has a wavelength selected from a predetermined plurality of wavelengths.

The method 100 further comprises receiving said second optical signal at an optical receiver apparatus 106. Said optical receiver apparatus is arranged to detect an optical signal having a wavelength within a receiving wavelength band. That is to say, the method 100 comprises detecting said second optical signal only when it is of a wavelength falling within said receiving wavelength band. In the case of a WDM optical network, said plurality of wavelengths comprise the wavelengths of a WDM grid, i.e. of the channels of the optical network, and said receiving wavelength band encompasses the wavelength of a single channel or a single WDM grid wavelength.

In the case where second optical signal is at a wavelength which falls within said receiving wavelength band 108a, the method 100 further comprises detecting said second optical signal at said optical receiver apparatus 110. Subsequent to the detection of the second optical signal the method comprises generating and transmitting said first optical signal in a second signal format 112. The change in the first optical signal format is detected 114 and the method 100 comprises subsequently maintaining the wavelength of the second optical signal at the wavelength at which the second optical signal was detected 116.

In the case where the second optical signal is not at a wavelength within said receiving wavelength band 108b, the method 100 comprises further generating and transmitting the first optical signal in the first signal format 118. The method 100 further comprises generating and transmitting the second optical signal at a different wavelength selected from the predetermined plurality of wavelengths 120.

The method 100 comprises iteratively generating and transmitting the second optical signal at different wavelengths of the predetermined plurality of wavelengths until the second optical signal is detected by the optical receiver apparatus.

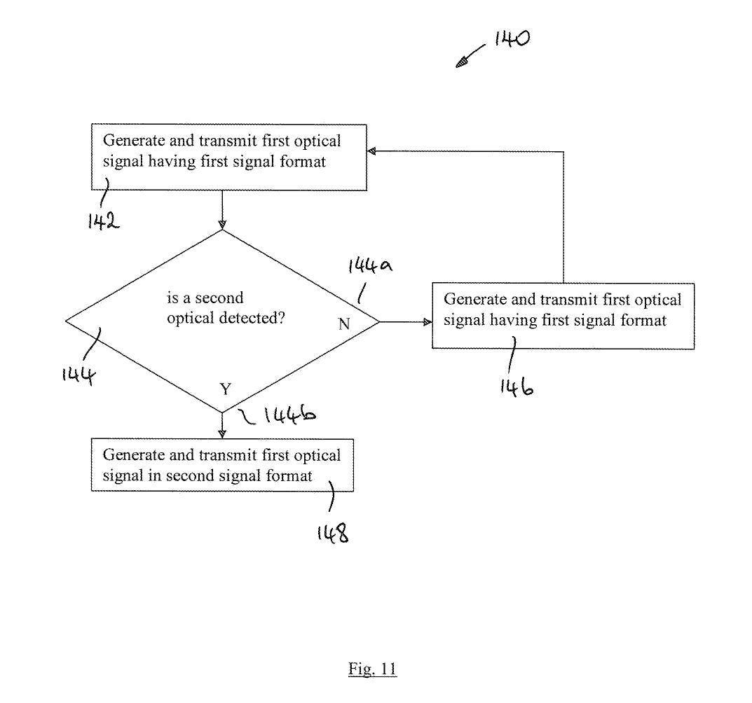

FIG. 10 shows the steps of a method 130 of configuring a wavelength of an optical transmitter in an optical network according to a seventh embodiment of the invention.

The method 130 of this embodiment is substantially the same as the method 100 of the previous embodiment, with the following modifications. The same reference numbers are retained for corresponding steps.

In this embodiment, the method 130 comprises generating and transmitting a first optical signal having a pulsed signal format 132, 138 until the second optical signal is detected. The method 130 further comprises generating and transmitting the first optical signal having a continuous wave signal formal 136 subsequent to detecting the second optical signal.

The method 130 further comprises detecting the second optical signal only when its signal power is greater than or equal to an optical receiver sensitivity threshold 134.

An eighth embodiment of the invention provides a method 140 of remotely setting a wavelength of an optical transmitter in an optical network, as shown in FIG. 11.

The method 140 comprises, at a location remote from said optical transmitter, generating and transmitting a first optical signal having a first signal format 142. The method 140 comprises continuing to generate and transmit the first optical signal having a first signal format until a second optical signal is detected 144a, 144b, 146. The second optical signal is generated and transmitted by the optical transmitter whose wavelength is to be set. The method 140 further comprises, subsequent to detecting the second optical signal, generating and transmitting the first optical signal in a second signal format 148.

In one embodiment, the first signal format comprises a pulsed optical signal and the second signal format comprises a continuous wave optical signal.

The second optical signal is detected only when it has an optical power which is equal to or greater than an optical receiver sensitivity threshold.

A ninth embodiment of the invention provides a data carrier having computer readable instructions embodied therein. The computer readable instructions are for providing access to resources available on a processor. The computer readable instructions comprise instructions to cause the processor to perform the steps of the method of configuring a wavelength of an optical transmitter in an optical network of the sixth or seventh embodiment of the invention, as described above.

A tenth embodiment of the invention provides a data carrier having computer readable instructions embodied therein. The computer readable instructions are for providing access to resources available on a processor. The computer readable instructions comprise instructions to cause the processor to perform the steps of the method of remotely setting a wavelength of an optical transmitter in an optical network of the eighth embodiment of the invention, as described above.

1. An optical network comprising:
a first optical transmitter arranged to generate and transmit a first optical signal; a first controller arranged to control said first optical transmitter to apply a signal format to said first optical signal; optical receiver apparatus arranged to detect an optical signal having a wavelength within a receiving wavelength band;
an optical network element comprising an optical receiver arranged to detect a said first optical signal, a second optical transmitter arranged to generate and transmit a second optical signal, and a second controller arranged to control said second optical transmitter to generate and transmit said second optical signal at a wavelength selected from a predetermined plurality of wavelengths,
said first controller being arranged to control said first optical transmitter to apply a first signal format to said first optical signal until said optical receiver apparatus detects said second optical signal and to subsequently control said first optical transmitter to apply a second signal format to said first optical signal, and
said second controller being arranged to identify said signal format of a received first optical signal and being arranged to control said second optical transmitter to iteratively generate and transmit said second optical signal at different wavelengths of said predetermined plurality of wavelengths until said second controller identifies a received first optical signal as having said second signal format,
and said second controller being further arranged to subsequently maintain generation and transmission of said second optical signal at said wavelength at which said first optical signal is identified as having said second signal format.

2. An optical network as claimed in claim 1, wherein said optical receiver apparatus comprises an optical detector coupled to an output port of a wavelength selective router and said output port is arranged to transmit an optical signal having a wavelength within said receiving wavelength band.

3. An optical network as claimed in claim 2, wherein said wavelength selective router comprises an arrayed waveguide grating.

4. An optical network as claimed in claim 2, wherein said optical detector has a sensitivity threshold which is higher than a maximum adjacent crosstalk of said output port.

5. An optical network as claimed in claim 4, wherein said second optical transmitter is arranged to generate and transmit a second optical signal having an optical power which is not greater than a difference between said sensitivity threshold and an attenuation experienced by said second optical signal.

6. An optical network as claimed in claim 1, wherein said first optical signal format comprises a pulsed optical signal and said second optical signal comprises a continuous wave optical signal.

7. An optical network as claimed in claim 1, wherein said second controller is arranged to control said second optical transmitter to transmit said second optical signal in response to detecting said first optical signal.

8. An optical network as claimed in claim 6, wherein said second controller is arranged to control said second optical transmitter to transmit said second optical signal in response to detecting an edge of a pulse of said pulsed optical signal.

9. An optical network as claimed in claim 1, wherein said optical network comprises a plurality of said optical network elements, a corresponding plurality of first optical transmitters and a corresponding plurality of optical detectors each arranged to detect an optical signal having a wavelength within a different receiving wavelength band, said optical detectors being coupled to respective output ports of said arrayed waveguide grating.

10. An optical network element comprising:
an optical receiver arranged to detect a first optical signal;
an optical transmitter arranged to generate and transmit a second optical signal; and a controller arranged to control said optical transmitter to generate and transmit said second optical signal at a wavelength selected from a predetermined plurality of wavelengths,
said controller being arranged to identify a signal format of a received first optical signal and being arranged to control said optical transmitter to iteratively generate and transmit said second optical signal at different wavelengths of said predetermined plurality of wavelengths until said controller identifies a received first optical signal as having a second signal format,
and said controller being further arranged to subsequently maintain generation and transmission of said second optical signal at said wavelength at which said first optical signal is identified as having said second signal format.

11. An optical line termination comprising:
an optical transmitter arranged to generate and transmit a first optical signal;
a controller arranged to control said optical transmitter to apply a signal format to said first optical signal; and optical receiver apparatus arranged to detect an optical signal having a wavelength within a receiving wavelength band;
said controller being arranged to control said optical transmitter to apply a first signal format to said first optical signal until said optical receiver apparatus detects a second optical signal and to subsequently control said optical transmitter to apply a second signal format to said first optical signal.

12. A method of configuring an optical transmitter in an optical network, the method comprising:
a. generating and transmitting a first optical signal having a first signal format;
b. at said optical transmitter, generating and transmitting a second optical signal at a wavelength selected from a predetermined plurality of wavelengths;
c. receiving said second optical signal at an optical receiver apparatus arranged to detect an optical signal having a wavelength within a receiving wavelength band; and
d. if said second optical signal is at a wavelength within said receiving wavelength band: detecting said second optical signal at said optical receiver apparatus; generating and transmitting said first optical signal in a second signal format; and detecting a change in said first optical signal format and maintaining said wavelength of said second optical signal at said wavelength at which said second optical signal is detected; or
e. if said second optical signal is not at a wavelength within said receiving wavelength band: further generating and transmitting said first optical signal in said first signal format and generating and transmitting said second optical signal at a different wavelength selected from said predetermined plurality of wavelengths, wherein steps c. to e. are repeated until said second optical signal is detected by said optical receiver apparatus.

13. A method as claimed in claim 12, wherein said first signal format comprises a pulsed optical signal and said second signal format comprises a continuous wave optical signal.

14. A method as claimed in claim 12, wherein said method comprises detecting said second optical signal only when said second optical signal has an optical power which is equal to or greater than an optical receiver sensitivity threshold.

15. A method as claimed in claim 14, wherein said second optical signal has an optical power which is not greater than the difference between said optical receiver sensitivity threshold and an attenuation experienced by said second optical signal.

16. A method of remotely setting a wavelength of an optical transmitter in an optical network, the method comprising:
a. at a location remote from said optical transmitter, generating and transmitting a first optical signal having a first signal format until a second optical signal, generated by said optical transmitter, is detected; and
b. subsequently generating and transmitting said first optical signal in a second signal format.

17. A method as claimed in claim 16, wherein said first signal format comprises a pulsed optical signal and said second signal format comprises a continuous wave optical signal.

18. A method as claimed in claim 16, wherein said method comprises detecting said second optical signal only when said second optical signal has an optical power which is equal to or greater than an optical receiver sensitivity threshold.
